(19) United States
(12) Patent Application Publication
(10) Pub. No.: US 2026/0184534 A1
(43) Pub. Date: Jul. 2, 2026

(54) INTELLIGENT CONTROL SYSTEM BASED ON ELEVATOR

(71) Applicant: LOCKIS TECHNOLOGY LIMITED, Hongkong (CN)

(72) Inventors: MAN SHUN SERVER LEUNG, HongKong (CN); Lok Shun LEUNG, HongKong (CN)

(21) Appl. No.: 19/432,228

(22) Filed: Dec. 24, 2025

(30) Foreign Application Priority Data
Dec. 27, 2024 (CN) 2024119545827

(51) Int. Cl. B66B 1/30; B66B 1/34; G06V 10/74; G06V 20/50

(52) U.S. Cl. CPC B66B 1/30; B66B 1/3461; G06V 10/761; G06V 20/50

(57) ABSTRACT

An intelligent control system based on an elevator is provided, which includes: a control terminal, configured to issue an execution command; a collection module, configured to collect characteristic parameters of a transportation target transported by the elevator; a configuration module, configured to: obtain the characteristic parameters of the transportation target transported by the elevator, and determine an operation logic for the elevator based on the characteristic parameters of the transportation target transported by the elevator; a monitoring module, configured to monitor whether the characteristic parameters of the transportation target transported by the elevator collected by the collection module are reused parameters; a driving module, configured to: receive the operation logic for the elevator from the configuration module, and apply the operation logic to control an operation of the elevator; and an output module, configured to output operation messages of the elevator.

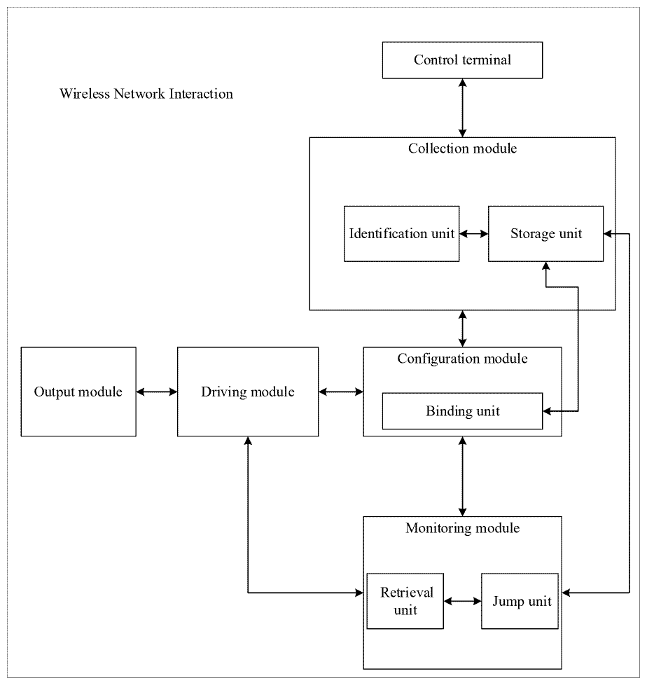

### CROSS-REFERENCE TO RELATED APPLICATION

The present disclosure claims the priority of Chinese Patent Application No. 202411954582.7, filed on Dec. 27, 2024, which is herein incorporated by reference in its entirety.

### TECHNICAL FIELD

The present disclosure relates to the technical field of elevators, in particular to an intelligent control system based on an elevator.

### BACKGROUND

An elevator is a vertical transportation device widely used in fields such as construction, warehousing, and industry. The elevator achieves smooth lifting and lowering of personnel or goods between different floors through motor drive and mechanical transmission. The elevator has characteristics such as a stabler structure, a simpler operation, and a stronger load-bearing capacity, which can greatly improve work efficiency, ensure transportation safety, and provide convenient solutions for various high-altitude operations and material handling.

A Chinese patent application with an application No. 202111608853.X discloses an intelligent operation control system for elevator lifting safety, which includes an elevator, and the elevator includes a collection module, a monitoring module, an interaction module, a warning module, and a processor, where the processor is respectively connected to and controls the collection module, the monitoring module, the interaction module, and the warning module. The collection module is used to collect weight and position data of a user entering the elevator. The monitoring module is used to monitor a docking position and an operating status of the elevator. The interaction module is used to interact with the user to prompt the user to perform control operations. The warning module is used to issue a warning signal to the user in emergency situations and prompt the user to perform emergency landing operations. The collection module includes a collection unit and a sensing unit. The collection unit is used to collect an action of the user entering the elevator and cooperate with the warning module and the interaction module to prompt the user. The sensing unit collects a position of the user in the elevator. The sensing unit includes a sensing plate and multiple position sensing elements. The sensing plate is disposed on a floor of the elevator car to collect the user's weight. Each of the multiple position sensing elements is distributed at equal intervals along a length direction of the sensing plate to collect the user's position.

This patent application aims to solve the problems of existing elevators having lower intelligence, lacking emergency protection, lacking self-inspection capability, and being unable to perform intelligent human-machine interaction.

However, for material transportation and freight-type elevators, they are currently often manually controlled to achieve the lifting and transportation of goods and materials. Yet, when dealing with transportation tasks for goods and materials of different weights, a power of the elevator is mostly a constant value. This leads to an operating cost of the elevator being measured solely based on a usage duration, resulting in lower energy-saving performance during an operation process of the elevator.

### SUMMARY

To address the shortcomings of the prior art, the present disclosure provides an intelligent control system based on an elevator, solving the technical problems mentioned in the background art above.

To achieve the above objectives, the present disclosure is implemented through the following technical solutions.

In an embodiment, an intelligent control system based on an elevator is provided, which includes: a control terminal, where the control terminal is a main control end of the intelligent control system and is configured to issue an execution command; a collection module, configured to collect characteristic parameters of a transportation target transported by the elevator; a configuration module, configured to: obtain the characteristic parameters of the transportation target transported by the elevator, and determine an operation logic for the elevator based on the characteristic parameters of the transportation target transported by the elevator; a monitoring module, configured to monitor whether the characteristic parameters of the transportation target transported by the elevator collected by the collection module are reused parameters; a driving module, configured to: receive the operation logic for the elevator from the configuration module, and apply the operation logic to control an operation of the elevator; and an output module, configured to output operation messages of the elevator. The control terminal is interactively connected to the collection module via a wireless network. The collection module includes an identification unit and a storage unit, which are interactively connected via the wireless network. The collection module is interactively connected to the configuration module via the wireless network. The configuration module internally is provided with a binding unit. The binding unit is interactively connected to the storage unit via the wireless network. The configuration module is interactively connected to the monitoring module via the wireless network. The monitoring module includes a retrieval unit and a jump unit, which are interactively connected to each other via the wireless network. The monitoring module is interactively connected to the storage unit via the wireless network. The configuration module is interactively connected to the driving module and the output module via the wireless network. The driving module is interactively connected to the retrieval unit via the wireless network.

Further, in an embodiment, the collection module includes sub-modules, and the sub-modules include the identification unit and the storage unit. The identification unit is configured to capture an appearance image and a mass of the transportation target transported by the elevator. The storage unit, configured to: receive the appearance image and the mass of the transportation target captured by the identification unit; determine whether the appearance image and the mass of the transportation target are required to be stored in the storage unit; and in response to determining that the appearance image and the mass of the transportation target are required to be stored in the storage unit, store the appearance image and the mass of the transportation target. The characteristic parameters of the transportation target transported by the elevator consist of the appearance image and the mass of the transportation target captured by the identification unit; and the storage unit is further configured to: perform a similarity comparison between the appearance image and the mass of the transportation target and appearance images and masses of other transportation targets already stored in the storage unit; and in response to a similar item being found, not store the appearance image and the mass of the transportation target.

Further, in an embodiment, a similarity between a group A consisting of the appearance image and the mass of the transportation target and a group B consisting of an appearance image and a mass of a corresponding one transportation target of the other transportation targets already stored in the storage unit is calculated through a first formula expressed as follows:

$$s i m ( A , B ) = [ ( 1 - \frac{{\sum }_{i = 0}^{n - 1} {\sum }_{j = 0}^{n - 1} \vert P ( A ( i , j ) ) - P ( B ( i , j ) ) \vert}{{n}^{2}} ) + {( \frac{{g}_{A}}{{g}_{B}} )}^{γ} ] / 2$$

where sim(A, B) represents the similarity between the group A consisting of the appearance image and the mass of the transportation target and the group B consisting of the appearance image and the mass of the corresponding one transportation target of the other transportation targets already stored in the storage unit, n² represents an image resolution, P(A (i, j)) represents a pixel value at a position (i, j) in the appearance image of the transportation target in the group A, P(B (i, j)) represents a pixel value at a position (i, j) in the appearance image of the corresponding one transportation target of the other transportation targets in the group B, g_{A} represents the mass of the transportation target in the group A, g_{B} represents the mass of the corresponding one transportation target of the other transportation targets in the group B, and γ represents an adjustment factor. During a calculation process of the similarity sim(A, B), the group B consisting of the appearance image and the mass of the corresponding one transportation target of the other transportation targets is obtained from the storage unit; based on the first formula, the similarity comparison is performed on the appearance image and the mass of the transportation target and each of groups consisting of appearance images and masses of the other transportation targets already stored in the storage unit; when a group consisting of an appearance image and a mass with a similarity greater than 95% with respect to the group A consisting of the appearance image and the mass of the transportation target is found from the groups, the appearance image and the mass of the transportation target is not stored in the storage unit; when a group consisting of an appearance image and a mass with a similarity greater than 95% with respect to the group A consisting of the appearance image and the mass of the transportation target is not found from the groups, the appearance image and the mass of the transportation target is stored in the storage unit

Further, in an embodiment, in the first formula,

$$\frac{{\sum }_{i = 0}^{n - 1} {\sum }_{j = 0}^{n - 1} \vert P ( A ( i , j ) ) - P ( B ( i , j ) ) \vert}{{n}^{2}}$$

represents an average pixel difference between the appearance image in the group A and the appearance image in the group B.

$$1 - \frac{{\sum }_{i = 0}^{n - 1} {\sum }_{j = 0}^{n - 1} \vert P ( A ( i , j ) ) - P ( B ( i , j ) ) \vert}{{n}^{2}}$$

represents a similarity between the appearance image in the group A and the appearance image in the group B. A value of the adjustment factor γ is 1 or −1, when g_{A}>g_{B}, γ=−1; when g_{A}≤g_{B}, γ=1.

Further, in an embodiment, the operation logic determined for the elevator by the configuration module includes: a travel height and a motor power for transporting the transportation target of the elevator. The travel height in the operation logic determined for the elevator is set by an end user of the intelligent control system, and the motor power for transporting the transportation target of the elevator is estimated and applied based on the characteristic parameters of the transportation target. The motor power for transporting the transportation target of the elevator is estimated by a second formula expressed as follows:

$$P = {P}_{0} + \frac{W \times s + {F}_{f} \times s + m \times a \times s}{η} \times λ$$

where P represents the motor power for transporting the transportation target of the elevator, P₀ represents a motor power under a no-load operation state of the elevator, W represents a weight of the transportation target, F_{f} represents a friction force generated during transporting the transportation target by the elevator, m represents a total mass of the transportation target and the elevator, a represents a transportation acceleration of the elevator, s represents a transportation speed of the elevator, η represents an efficiency of a motor and transmission system of the elevator, and λ represents a normalization factor. The efficiency η of the motor and transmission system of the elevator satisfies η∈[0.7, 0.9]; and the normalization factor λ is greater than 1, and the normalization factor λ follows a setting logic that the greater the weight W of the transportation target, the larger the value of the normalization factor λ, and the smaller the weight W of the transportation target, the smaller the value of the normalization factor λ.

Further, in an embodiment, the configuration module internally has a sub-module, and the sub-module includes a binding unit; and
where the binding unit is configured to:
   obtain an estimation result of the motor power for transporting the transportation target of the elevator;
   apply the estimation result to the elevator; and
   feed the estimation result back to the storage unit for binding the estimation result with the group consisting of the appearance image and the mass in the groups, which is already stored in the storage unit and has the similarity greater than 95% with respect to the group A consisting of the appearance image and the mass of the transportation target, or binding the estimation result with the group A consisting of the appearance image and the mass of the transportation target.

Further, in an embodiment, the monitoring module is specifically configured to:
monitor a similarity comparison result between the appearance image and the mass of the transportation target and each of the groups consisting of the appearance images and the masses of the other transportation targets already stored in the storage unit;
in response to the group consisting of the appearance image and the mass with the similarity greater than 95% with respect to the group A consisting of the appearance image and the mass of the transportation target is found from the groups, determine a monitoring result being “yes”;
in response to the group consisting of the appearance image and the mass with the similarity greater than 95% with respect to the group A consisting of the appearance image and the mass of the transportation target is not found from the groups, determine a monitoring result being “no”;
where when the monitoring result is “yes”, the retrieval unit of the monitoring module is configured to be triggered to:
   retrieve, from the storage unit, an estimation result corresponding to the group consisting of the appearance image and the mass with the similarity greater than 95% with respect to the group A consisting of the appearance image and the mass of the transportation target; and
where when the monitoring result is “no”, the jump unit of the monitoring module is configured to be triggered to: jump to the configuration module to operate.

Further, in an embodiment, after the retrieval unit is triggered to operate and a corresponding process is finished by the retrieval unit, the driving module is configured to operate; and when the jump unit is triggered to operate, the intelligent control system is configured to run to a running stage of the configuration module, and after the configuration module finishes the running stage, the driving module is configured to operate.

Further, in an embodiment, a content of the operation messages of the elevator outputted by the output module includes: the operation logic applied during the operation of the elevator, and an actual real-time motor power during the operation of the elevator based on the operation logic.

The technical solutions provided by the present disclosure, compared with the known public technology, have the following beneficial effects.

The present disclosure provides the intelligent control system based on an elevator. During the operation of this system, by collecting the appearance image and the mass of the transportation target, targeted operation logic is configured for the elevator, thereby controlling an operating power of the elevator to match the operating power with the transportation target. This allows the operating power of the elevator to be adjusted according to an actual situation of the transportation target, ultimately achieving intelligent control of the elevator's operating power. Furthermore, controlling the elevator's operating power brings about energy-saving management of operation, making the operating cost of the elevator no longer limited to operating time.

### BRIEF DESCRIPTION OF DRAWING

To describe the technical solutions in the embodiments of the present disclosure or in the prior art more clearly, the following briefly introduces the accompanying drawings required for describing the embodiments or the prior art. Obviously, the accompanying drawings in the following description show merely some embodiments of the present disclosure, and a person of ordinary skill in the art may still derive other drawings from these accompanying drawings without creative efforts.

FIGURE illustrate a schematic structural view of an intelligent control system for an elevator according to an embodiment of the present disclosure.

### DETAILED DESCRIPTION OF EMBODIMENTS

To make objectives, technical solutions, and advantages of embodiments of the present disclosure clearer, the following clearly and completely describes the technical solutions in the embodiments of the present disclosure with reference to an accompanying drawing in the embodiments of the present disclosure Apparently, the described embodiments are some, but not all, of embodiments of the present disclosure. Based on the embodiments of the present disclosure, all other embodiments obtained by a person of ordinary skill in the art without creative efforts shall fall within the protection scope of the present disclosure.

The present disclosure is further described below with reference to the embodiments.

### Embodiment 1

An intelligent control system based on an elevator according to the embodiment 1 is provided, as shown in FIGURE, which includes: a control terminal, a collection module, a configuration module, a monitoring module, a driving module, and an output module.

The control terminal is a main control end of the intelligent control system and is configured to issue an execution command.

The collection module is configured to collect characteristic parameters of a transportation target transported by the elevator.

The collection module includes sub-modules, and the sub-modules include an identification unit and a storage unit. The identification unit is configured to capture an appearance image and a mass of the transportation target transported by the elevator. The storage unit is configured to: receive the appearance image and the mass of the transportation target captured by the identification unit; determine whether the appearance image and the mass of the transportation target are required to be stored in the storage unit; and in response to determining that the appearance image and the mass of the transportation target are required to be stored in the storage unit, store the appearance image and the mass of the transportation target.

Specifically, the characteristic parameters of the transportation target transported by the elevator consist of the appearance image and the mass of the transportation target captured by the identification unit; and the storage unit is further configured to: perform a similarity comparison between the appearance image and the mass of the transportation target and appearance images and masses of other transportation targets already stored in the storage unit; and in response to a similar item being found, not store the appearance image and the mass of the transportation target.

A similarity between a group A consisting of the appearance image and the mass of the transportation target and a group B consisting of an appearance image and a mass of a corresponding one transportation target of the other transportation targets already stored in the storage unit is calculated through a first formula expressed as follows:

$$s i m ( A , B ) = [ ( 1 - \frac{{\sum }_{i = 0}^{n - 1} {\sum }_{j = 0}^{n - 1} \vert P ( A ( i , j ) ) - P ( B ( i , j ) ) \vert}{{n}^{2}} ) + {( \frac{{g}_{A}}{{g}_{B}} )}^{γ} ] / 2$$

where sim(A, B) represents the similarity between the group A consisting of the appearance image and the mass of the transportation target and the group B consisting of the appearance image and the mass of the corresponding one transportation target of the other transportation targets already stored in the storage unit, n² represents an image resolution, P(A (i, j)) represents a pixel value at a position (i, j) in the appearance image of the transportation target in the group A, P(B (i, j)) represents a pixel value at a position (i, j) in the appearance image of the corresponding one transportation target of the other transportation targets in the group B, g_{A} represents the mass of the transportation target in the group A, g_{B} represents the mass of the corresponding one transportation target of the other transportation targets in the group B, and γ represents an adjustment factor.

During the calculation of the similarity sim(A, B), the group B consisting of the appearance image and the mass of the corresponding one transportation target of the other transportation targets is obtained from the storage unit. Based on the first formula, the similarity comparison is performed on the appearance image and the mass of the transportation target and each of groups consisting of appearance images and masses of the other transportation targets already stored in the storage unit. When a group consisting of an appearance image and a mass with a similarity greater than 95% with respect to the group A consisting of the appearance image and the mass of the transportation target is found from the groups, the appearance image and the mass of the transportation target is not stored in the storage unit, i.e., the appearance image and the mass of the transportation target is discarded. Otherwise, the appearance image and the mass of the transportation target is stored in the storage unit.

$$\frac{{\sum }_{i = 0}^{n - 1} {\sum }_{j = 0}^{n - 1} \vert P ( A ( i , j ) ) - P ( B ( i , j ) ) \vert}{{n}^{2}}$$

represents an average pixel difference between the appearance image in the group A and the appearance image in the group B.

$$1 - \frac{{\sum }_{i = 0}^{n - 1} {\sum }_{j = 0}^{n - 1} \vert P ( A ( i , j ) ) - P ( B ( i , j ) ) \vert}{{n}^{2}}$$

represents a similarity between the appearance image in the group A and the appearance image in the group B.

A value of the adjustment factor γ is 1 or −1, when g_{A}>g_{B}, γ=−1; when g_{A}≤g_{B}, γ=1.

The configuration module is configured to obtain the characteristic parameters of the transportation target transported by the elevator, and determine an operation logic for the elevator based on the characteristic parameters of the transportation target transported by the elevator.

The monitoring module is configured to monitor whether the characteristic parameters of the transportation target transported by the elevator collected by the collection module are reused parameters.

The driving module is configured to receive the operation logic for the elevator from the configuration module, and apply the operation logic to control an operation of the elevator.

The output module is configured to output operation messages of the elevator.

A content of the operation messages of the elevator outputted by the output module includes: the operation logic applied during the operation of the elevator, and an actual real-time motor power during the operation of the elevator based on the operation logic.

The control terminal is interactively connected to the collection module via a wireless network. The identification unit and the storage unit of the collection module are interactively connected via the wireless network. The collection module is interactively connected to the configuration module via the wireless network. The configuration module internally is provided with a binding unit. The binding unit is interactively connected to the storage unit via the wireless network. The configuration module is interactively connected to the monitoring module via the wireless network. The monitoring module includes a retrieval unit and a jump unit, which are interactively connected to each other via the wireless network. The monitoring module is interactively connected to the storage unit via the wireless network. The configuration module is interactively connected to the driving module and the output module via the wireless network. The driving module is interactively connected to the retrieval unit via the wireless network.

In this embodiment, the control terminal is configured to control the collection module to operate and collect the characteristic parameters of the transportation target corresponding to the elevator. During an operation of the collection module, the identification unit is configured to simultaneously capture the appearance image and the mass of the transportation target, and the storage unit is configured to receive the appearance image and the mass of the transportation target captured by the identification unit in real time and determine whether to store the appearance image and the mass of the transportation target. The configuration module is configured to obtain the characteristic parameters of the transportation target transported by the elevator and determine the operation logic for the elevator based on the characteristic parameters of the transportation target. The binding unit is configured to simultaneously obtain an estimation result of the motor power for transporting the transportation target of the elevator, apply the estimation result to the elevator, and feed the estimation result back to the storage unit for binding the estimation result with the group consisting of the appearance image and the mass in the groups, which is already stored in the storage unit and has the similarity greater than 95% with respect to the group A consisting of the appearance image and the mass of the transportation target, or binding the estimation result with the group A consisting of the appearance image and the mass of the transportation target. The monitoring module is further configured to: monitor a similarity comparison result between the appearance image and the mass of the transportation target and each of the groups consisting of the appearance images and the masses of the other transportation targets already stored in the storage unit; in response to the group consisting of the appearance image and the mass with the similarity greater than 95% with respect to the group A consisting of the appearance image and the mass of the transportation target is found from the groups, determine a monitoring result being “yes”; in response to the group consisting of the appearance image and the mass with the similarity greater than 95% with respect to the group A consisting of the appearance image and the mass of the transportation target is not found from the groups, determine a monitoring result being “no”. When a monitoring result of the monitoring module is “yes”, the retrieval unit is configured to be triggered to: retrieve, from the storage unit, an estimation result corresponding to the group consisting of the appearance image and the mass with the similarity greater than 95% with respect to the group A consisting of the appearance image and the mass of the transportation target. When the monitoring result of the monitoring module is “no”, the jump unit is configured to be triggered to: jump to the configuration module to operate. The driving module is configured to: receive the operation logic for the elevator configured in the configuration module and apply the elevator operation logic to control the operation of the elevator. Finally, the output module is configured to output the operation messages of the elevator.

Through the operation of the intelligent control system described in the above embodiment, intelligent control of an operating power is brought to the elevator, enabling the elevator to stably perform lifting and lowering transportation tasks while reducing a degree of energy waste generated by the operating power.

### Embodiment 2

At a specific implementation level, based on Embodiment 1, the embodiment 2 further elaborates on the intelligent control system based on the elevator in the Embodiment 1 with reference to the FIGURE.

The operation logic determined for the elevator by the configuration module includes: a travel height and a motor power for transporting the transportation target of the elevator.

The travel height in the operation logic determined for the elevator is set by an end user of the intelligent control system, and the motor power for transporting the transportation target of the elevator is estimated and applied based on the characteristic parameters of the transportation target.

The motor power for transporting the transportation target of the elevator is estimated by the following formula:

$$P = {P}_{0} + \frac{W \times s + {F}_{f} \times s + m \times a \times s}{η} \times λ$$

where P represents motor power during the lifting and lowering transportation process of the elevator, P₀ represents a motor power during a lifting and lowering process with no load of the elevator, W represents a weight of the transportation target, F_{f} represents a friction force generated during the lifting and lowering transportation process of the elevator, m represents a total mass of the transportation target and the elevator, a represents an acceleration of the elevator during the lifting and lowering transportation process of the elevator, s represents a speed of the elevator during the lifting and lowering transportation process of the elevator, η represents an efficiency of a motor and a transmission system of the elevator, and λ represents a normalization factor.

Specifically, the efficiency η of the motor and the transmission system of the elevator satisfies η∈[0.7, 0.9]. The normalization factor λ is greater than 1, and follows a setting logic that the greater the weight W of the transportation target, the larger the value of the normalization factor λ, and conversely, the smaller the weight W of the transportation target, the smaller the value of the normalization factor λ.

The configuration module internally has a sub-module, which includes the binding unit.

The binding unit is configured to: obtain an estimation result of the motor power for transporting the transportation target of the elevator; apply the estimation result to the elevator; and feed the estimation result back to the storage unit for binding the estimation result with the group consisting of the appearance image and the mass in the groups, which is already stored in the storage unit and has the similarity greater than 95% with respect to the group A consisting of the appearance image and the mass of the transportation target, or binding the estimation result with the group A consisting of the appearance image and the mass of the transportation target.

In this embodiment, through the above settings, an estimation logic for the motor power for transporting the transportation target of the elevator is further defined, and based on the operation of the binding unit, the estimation result is further bound with the appearance image and mass parameters of the transportation target stored in the storage unit and stored.

### Embodiment 3

At a specific implementation level, based on Embodiment 1, the embodiment 3 further elaborates on the intelligent control system based on the elevator in the Embodiment 1 with reference to the FIGURE.

The monitoring module is specifically configured to: monitor a similarity comparison result between the appearance image and the mass of the transportation target and each of the groups consisting of the appearance images and the masses of the other transportation targets already stored in the storage unit; in response to the group consisting of the appearance image and the mass with the similarity greater than 95% with respect to the group A consisting of the appearance image and the mass of the transportation target is found from the groups, determine a monitoring result being “yes”; in response to the group consisting of the appearance image and the mass with the similarity greater than 95% with respect to the group A consisting of the appearance image and the mass of the transportation target is not found from the groups, determine a monitoring result being “no”.

When the monitoring result is “yes”, a retrieval unit of the monitoring module is configured to be triggered to: retrieve, from the storage unit, an estimation result corresponding to the group consisting of the appearance image and the mass with the similarity greater than 95% with respect to the group A consisting of the appearance image and the mass of the transportation target.

when the monitoring result is “no”, a jump unit of the monitoring module is configured to be triggered to: jump to the configuration module to operate.

After the retrieval unit is triggered to operate and a corresponding process is finished by the retrieval unit, the driving module is configured to operate.

When the jump unit is triggered to operate, the intelligent control system is configured to run to a running stage of the configuration module, and after the configuration module finishes the running stage, the driving module is configured to operate.

In this embodiment, through the above settings, further operational logic support is provided for the operation of the intelligent control system in Embodiment 1, ensuring that the settings in Embodiment 3 can further assist the system operation in Embodiment 1 to bring continuous intelligent control to the elevator.

It should be noted, in an embodiment, each of the control terminal, the collection module including the identification unit and the storage unit, the configuration module including the binding unit, the monitoring module including the retrieval unit and the jump unit, the driving module, and the output module is embodied by at least one processor and at least one memory coupled to the at least one processor, and the at least one memory stores computer programs executable by the at least one processor. Alternatively, in an embodiment, the control terminal, the collection module including the identification unit and the storage unit, the configuration module including the binding unit, the monitoring module including the retrieval unit and the jump unit, the driving module, and the output module may be implemented/embodied by one or more memories stored software modules therein and one or more processors coupled to the one or more memories and configured to execute the software modules.

In summary, during the operation of the intelligent control system in the above embodiments, by collecting the appearance image and mass parameters of the transportation target, targeted operation logic is configured for the elevator, thereby controlling the operating power of the elevator to match the operating power with the transportation target. This allows the operating power of the elevator to be adjusted according to the actual situation of the transportation target, ultimately achieving intelligent control of the operating power of the elevator. Furthermore, controlling the operating power of the elevator brings about energy-saving management of operation, making the operating cost of the elevator no longer limited to operating time.

The above embodiments are only used to illustrate the technical solutions of the present disclosure and are not intended to limit them; although the present disclosure has been described in detail with reference to the foregoing embodiments, those of ordinary skill in the art should understand that: they can still modify the technical solutions described in the foregoing embodiments or perform equivalent replacements of some of the technical features; and these modifications or replacements do not cause the essence of the corresponding technical solutions to depart from the spirit and scope of the technical solutions of the embodiments of the present disclosure.

What is claimed is:

1. An intelligent control system based on an elevator, wherein the intelligent control system comprises:
a control terminal, wherein the control terminal is a main control end of the intelligent control system and is configured to issue an execution command;
a collection module, configured to collect characteristic parameters of a transportation target transported by the elevator;
a configuration module, configured to: obtain the characteristic parameters of the transportation target transported by the elevator, and determine an operation logic for the elevator based on the characteristic parameters of the transportation target transported by the elevator;
a monitoring module, configured to monitor whether the characteristic parameters of the transportation target transported by the elevator collected by the collection module are reused parameters;
a driving module, configured to: receive the operation logic for the elevator from the configuration module, and apply the operation logic to control an operation of the elevator; and
an output module, configured to output operation messages of the elevator.

2. The intelligent control system based on the elevator as claimed in claim 1, wherein the collection module comprises sub-modules, and the sub-modules comprises:
an identification unit, configured to capture an appearance image and a mass of the transportation target transported by the elevator; and
a storage unit, configured to: receive the appearance image and the mass of the transportation target captured by the identification unit; determine whether the appearance image and the mass of the transportation target are required to be stored in the storage unit; and in response to determining that the appearance image and the mass of the transportation target are required to be stored in the storage unit, store the appearance image and the mass of the transportation target; and
wherein the characteristic parameters of the transportation target transported by the elevator consist of the appearance image and the mass of the transportation target captured by the identification unit; and the storage unit is further configured to: perform a similarity comparison between the appearance image and the mass of the transportation target and appearance images and masses of other transportation targets already stored in the storage unit; and in response to a similar item being found, not store the appearance image and the mass of the transportation target.

3. The intelligent control system based on the elevator as claimed in claim 2, wherein a similarity between a group A consisting of the appearance image and the mass of the transportation target and a group B consisting of an appearance image and a mass of a corresponding one transportation target of the other transportation targets already stored in the storage unit is calculated through a first formula expressed as follows:
$$s i m ( A , B ) = [ ( 1 - \frac{{\sum }_{i = 0}^{n - 1} {\sum }_{j = 0}^{n - 1} \vert P ( A ( i , j ) ) - P ( B ( i , j ) ) \vert}{{n}^{2}} ) + {( \frac{{g}_{A}}{{g}_{B}} )}^{γ} ] / 2$$
where sim(A, B) represents the similarity between the group A consisting of the appearance image and the mass of the transportation target and the group B consisting of the appearance image and the mass of the corresponding one transportation target of the other transportation targets already stored in the storage unit, n² represents an image resolution, P(A (i, j)) represents a pixel value at a position (i, j) in the appearance image of the transportation target in the group A, P(B (i, j)) represents a pixel value at a position (i, j) in the appearance image of the corresponding one transportation target of the other transportation targets in the group B, g_{A} represents the mass of the transportation target in the group A, g_{B} represents the mass of the corresponding one transportation target of the other transportation targets in the group B, and γ represents an adjustment factor; and
wherein during a calculation process of the similarity sim(A, B), the group B consisting of the appearance image and the mass of the corresponding one transportation target of the other transportation targets is obtained from the storage unit; based on the first formula, the similarity comparison is performed on the appearance image and the mass of the transportation target and each of groups consisting of appearance images and masses of the other transportation targets already stored in the storage unit; when a group consisting of an appearance image and a mass with a similarity greater than 95% with respect to the group A consisting of the appearance image and the mass of the transportation target is found from the groups, the appearance image and the mass of the transportation target is not stored in the storage unit; when a group consisting of an appearance image and a mass with a similarity greater than 95% with respect to the group A consisting of the appearance image and the mass of the transportation target is not found from the groups, the appearance image and the mass of the transportation target is stored in the storage unit.

4. The intelligent control system based on the elevator as claimed in claim 3, wherein in the first formula,
$$\frac{{\sum }_{i = 0}^{n - 1} {\sum }_{j = 0}^{n - 1} \vert P ( A ( i , j ) ) - P ( B ( i , j ) ) \vert}{{n}^{2}}$$
represents an average pixel difference between the appearance image in the group A and the appearance image in the group B;
wherein
$$1 - \frac{{\sum }_{i = 0}^{n - 1} {\sum }_{j = 0}^{n - 1} \vert P ( A ( i , j ) ) - P ( B ( i , j ) ) \vert}{{n}^{2}}$$
represents a similarity between the appearance image in the group A and the appearance image in the group B; and
wherein a value of the adjustment factor γ is 1 or −1, when g_{A}>g_{B}, γ=−1; when g_{A}≤g_{B}, γ=1.

5. The intelligent control system based on the elevator as claimed in claim 4, wherein the operation logic determined for the elevator by the configuration module comprises: a travel height and a motor power for transporting the transportation target of the elevator;
wherein the travel height in the operation logic determined for the elevator is set by an end user of the intelligent control system, and the motor power for transporting the transportation target of the elevator is estimated and applied based on the characteristic parameters of the transportation target;
wherein the motor power for transporting the transportation target of the elevator is estimated by a second formula expressed as follows:
$$P = {P}_{0} + \frac{W \times s + {F}_{f} \times s + m \times a \times s}{η} \times λ$$
where P represents the motor power for transporting the transportation target of the elevator, P₀ represents a motor power under a no-load operation state of the elevator, W represents a weight of the transportation target, F_{f} represents a friction force generated during transporting the transportation target by the elevator, m represents a total mass of the transportation target and the elevator, a represents a transportation acceleration of the elevator, s represents a transportation speed of the elevator, n represents an efficiency of a motor and transmission system of the elevator, and λ represents a normalization factor; and
wherein the efficiency η of the motor and transmission system of the elevator satisfies η∈[0.7, 0.9]; and the normalization factor λ is greater than 1, and the normalization factor λ follows a setting logic that the greater the weight W of the transportation target, the larger the value of the normalization factor λ, and the smaller the weight W of the transportation target, the smaller the value of the normalization factor λ.

6. The intelligent control system based on the elevator as claimed in claim 5, wherein the configuration module internally has a sub-module, and the sub-module comprises a binding unit; and
wherein the binding unit is configured to:
obtain an estimation result of the motor power for transporting the transportation target of the elevator;
apply the estimation result to the elevator; and
feed the estimation result back to the storage unit for binding the estimation result with the group consisting of the appearance image and the mass in the groups, which is already stored in the storage unit and has the similarity greater than 95% with respect to the group A consisting of the appearance image and the mass of the transportation target, or binding the estimation result with the group A consisting of the appearance image and the mass of the transportation target.

7. The intelligent control system based on the elevator as claimed in claim 6, wherein the monitoring module is specifically configured to:
monitor a similarity comparison result between the appearance image and the mass of the transportation target and each of the groups consisting of the appearance images and the masses of the other transportation targets already stored in the storage unit;
in response to the group consisting of the appearance image and the mass with the similarity greater than 95% with respect to the group A consisting of the appearance image and the mass of the transportation target is found from the groups, determine a monitoring result being “yes”;
in response to the group consisting of the appearance image and the mass with the similarity greater than 95% with respect to the group A consisting of the appearance image and the mass of the transportation target is not found from the groups, determine a monitoring result being “no”;
wherein when the monitoring result is “yes”, a retrieval unit of the monitoring module is configured to be triggered to:
retrieve, from the storage unit, the estimation result corresponding to the group consisting of the appearance image and the mass with the similarity greater than 95% with respect to the group A consisting of the appearance image and the mass of the transportation target; and
wherein when the monitoring result is “no”, a jump unit of the monitoring module is configured to be triggered to: jump to the configuration module to operate.

8. The intelligent control system based on the elevator as claimed in claim 7, wherein after the retrieval unit is triggered to operate and a corresponding process is finished by the retrieval unit, the driving module is configured to operate; and
wherein when the jump unit is triggered to operate, the intelligent control system is configured to run to a running stage of the configuration module, and after the configuration module finishes the running stage, the driving module is configured to operate.

9. The intelligent control system based on the elevator as claimed in claim 1, wherein a content of the operation messages of the elevator outputted by the output module comprises: the operation logic applied during the operation of the elevator, and an actual real-time motor power during the operation of the elevator based on the operation logic.

10. The intelligent control system based on the elevator as claimed in claim 1, wherein the control terminal is interactively connected to the collection module via a wireless network; an identification unit and a storage unit of the collection module are interactively connected via the wireless network; the collection module is interactively connected to the configuration module via the wireless network; the configuration module internally is provided with a binding unit; the binding unit is interactively connected to the storage unit via the wireless network; the configuration module is interactively connected to the monitoring module via the wireless network; the monitoring module comprises a retrieval unit and a jump unit, which are interactively connected to each other via the wireless network; the monitoring module is interactively connected to the storage unit via the wireless network; the configuration module is interactively connected to the driving module and the output module via the wireless network; and the driving module is interactively connected to the retrieval unit via the wireless network.
